(19) United States
(12) Patent Application Publication
(10) Pub. No.: US 2020/0092084 A1
(43) Pub. Date: Mar. 19, 2020

(54) SYSTEM AND METHODS FOR OPERATING A BLOCKCHAIN NETWORK

(71) Applicant: TERNiO, LLC, Alpharetta, GA (US)

(72) Inventors: Bryant Maroney, Grand Ledge, MI (US); Corey Ballou, Charlotte, NC (US)

(21) Appl. No.: 16/575,126

(22) Filed: Sep. 18, 2019

Related U.S. Application Data
(60) Provisional application No. 62/732,798, filed on Sep. 18, 2018.

(51) Int. Cl. H04L 9/06; H04L 29/08

(52) U.S. Cl. CPC H04L 9/0637; H04L 2209/38; H04L 67/1002; H04L 9/0643

(57) ABSTRACT

A system for processing a blockchain transaction includes a first server operating a communications layer, and a second server operating a load balancer. The system includes a third plurality of servers, each comprising a ledger set, and a plurality of groups of consent nodes. Each group of consent nodes is associated with a ledger set. The second server routes transactions by selecting a first ledger set and determining whether the volume of transactions being processed on the first ledger set exceeds a threshold volume. The second server selects and uses the first ledger set to complete the transaction if the volume of transactions is less than the threshold volume. If the volume of transactions is greater than the threshold volume the second server causes a second ledger set to be created, and selects the second ledger set to complete the transaction.

### PRIOR-FILED APPLICATION

This application claims priority to U.S. Provisional Patent Application Ser. No. 62/732,798, entitled SYSTEM AND METHODS FOR OPERATING A BLOCKCHAIN NETWORK filed on Sep. 18, 2018, which is incorporated herein by reference.

### TECHNICAL FIELD

This invention relates to the field of computer networks used in connection with operation of a blockchain.

### BACKGROUND

A “blockchain” may be understood to be a distributed method of agreement and storage that keeps a continuously growing list of data records, wherein a growing list of records are linked using cryptography. Each record is protected against tampering and revisions by the use of cryptography and decentralization. Blockchains are used with public ledgers of transactions, where the record is enforced cryptographically.

Blockchains have enormous potential to provide transparency and security to various industries and use cases. As such, there are use cases for blockchain that require the ability to process many millions of transactions per second. Current blockchain solutions, however, are only able to support thousands of transactions per second.

In the conventional blockchain landscape, single blockchain-based frameworks are generally not capable of a scalable solution for processing transactions. Accordingly, a need exists for a framework that is able to overcome latency and provide for high-frequency creation of blockchain contracts and execution of corresponding transactions.

### SUMMARY

In accordance with an illustrative embodiment, a method of computing blockchain-based transactions includes receiving request-associated data from an internet enabled device at an ingestion server, and generating a blockchain contract. The blockchain contract is generated by a ledger set based on the request-associated data at a ledger server. The illustrative method further includes increasing a number of ledger sets within a blockchain network when the number of contracts created per second exceeds a threshold transaction rate, wherein the threshold transaction rate corresponds to the number of contracts that the ledger set can process within a selected time period.

In accordance with another illustrative embodiment, a system for processing a blockchain transaction includes a first server operating a communications layer, and a second server operating a load balancer. The system further includes a third plurality of servers, with each of the third plurality of servers comprising a ledger set; and a plurality of groups of consent nodes. Each group of consent nodes is associated with a ledger set. The second server is operable to route transactions by selecting a first ledger set and determining whether the volume of transactions being processed on the first ledger set exceeds a threshold volume. The second server selects and uses the first ledger set to complete at least a portion of the transaction if the volume of transactions is less than the threshold volume. If the volume of transactions is greater than the threshold volume the second server causes a second ledger set to be created, and selects the second ledger set to complete at least the portion of the transaction.

### BRIEF DESCRIPTION OF THE DRAWINGS

FIGS. 1A and 1B (collectively, FIG. 1) are a schematic diagram showing a representative system for completing a high volume of blockchain transactions.

FIG. 2 is a flowchart showing a representative process for scaling a network to complete a high volume of blockchain transactions.

### DESCRIPTION

The present disclosure relates to a system in which a server (or server area) routes requests received from another device executing a common blockchain protocol to any number of blockchain instances of the same blockchain framework. In cases of high transaction frequency, the system is operable to increase a number of operating ledger sets of the blockchain framework. The increased number of ledger sets corresponds to an enhanced ability to process consented transactions within a time period. The representative system allows a server, or networks of servers (or other computing devices functioning as nodes) to compute and process transactions on a faster and larger scale than would be permitted by operating only a single ledger set of the blockchain framework.

For the purposes of this disclosure, the following terms shall have the meanings ascribed to them below:

The terms “a”, “an” and “the” are intended to include the plural forms as well, unless the context clearly indicates otherwise.

The term “blockchain” or “blockchain” means a distributed method of agreement and storage that keeps a continuously growing list of data records. Each data record is protected against tampering and revisions. Blockchains are used with public ledgers of transactions, where the record is enforced cryptographically.

The term “blockchain framework” means an application toolset or framework for operating a blockchain. The blockchain framework may relate to a software development kit (SDK), and may be specific to building on an existing blockchain technology. Examples of blockchain frameworks include Hyperledger Fabric and Corda.

The term “blockchain network” means a network of software modules, computers, and/or servers that communicate for the purpose of completing transactions, establishing a consensus, and storing data related to the blockchain.

The term “consent” means a process of three or more nodes agreeing that received information processed in a blockchain network is substantially accurate or includes a verified characteristic.

The term “consensus” means agreement on a single data value among distributed processes or systems. A consensus may be considered to be a process where nodes in a blockchain network provide a guaranteed ordering of the transaction and validating those blocks of transactions that need to be committed to the ledger. In a blockchain network, a consensus confirms the correctness of all transactions in a proposed block, according to endorsement and consensus policies.

The term “ledger set” means a single instance of a blockchain, whereas the term “blockchain” when associated with “ledger set” refers to the system as a whole (i.e., all of the instances/ledger sets working together).

The term “ledger” refers to a data storage mechanism for storing blockchain data that has been consented upon.

The term “node” means a software module residing on a server or other computing device that communicates within the blockchain network for the purpose of completing transactions, establishing a consensus, and storing data related to the blockchain. A node may be represented as a physical server, a virtual server, or container.

The term “server” means a computer program or a device that provides functionality for other programs or devices. A server may be a traditional hardware server or a virtual server, or a server area.

The term “transaction” means any type of blockchain-based transaction, whether referenced as a transaction or as a contract.

In accordance with an illustrative embodiment, a system for processing blockchain-based communications within a common blockchain environment is disclosed. In the system, two or more ledger sets utilize a common smart contract to send and receive transactional records associated with a transaction between parties to the transaction (such as a payor and payee). The transaction may occur within, for example, an advertising environment via an application programming interface (API). As referenced herein, a smart contract is a computer protocol or program residing within a blockchain whose purpose is to verify, validate, coordinate, and enforce contractual agreements between parties.

In accordance with another illustrative embodiment, a method for processing blockchain-based communication within a common blockchain environment includes receiving at a browser and via the application programming interface, a request from a website. The request is associated with information to and from one or more parties. The request generates a contract record through the blockchain environment. The method includes receiving information, generating a contract records by means of a consensus algorithm, and retrieving the contract record via an application programming interface.

In accordance with another illustrative embodiment, a method is disclosed that increases the number of transactions a blockchain framework is able to successfully receive and process. Here, receiving and processing the transactions includes transfer of information, contract creation, consensus algorithm, and writing of transaction data to a ledger set's nodes.

The representative systems and methods described herein provide for creating, recording, holding, and transferring of blockchain contracts and records while also providing for scalability and a corresponding increase in the throughput of transactions (per second) within a series of blockchain frameworks operating within a common blockchain environment. Multiple blockchain frameworks may communicate within a series of blockchain frameworks to, for example, create, record, hold, and transfer advertisement impressions with enhanced throughput.

Broadly, the representative systems and methods described herein may be understood as including the following components or modules:

(A) Ingestion: The ingestion mechanism may be a process through which transaction data (which may be referenced as “a transaction”) is received from one or more parties via an API. The ingestion mechanism is comprised of an application that operates on highly available servers. The ingestion mechanism receives incoming transactions, processes them, and stores the transactions in a managed, horizontally scalable queue. In this context, “highly available” refers to a system that includes redundant resources to ensure durability and continuous operation for a long period of time.

The ingestion mechanism receives the information, combines any of the necessary information from one or more parties, and holds the information in a queue. In the context of an advertising transaction, for example, the necessary information may include real-time advertisement bidding data from an OpenRTB specification document pertaining to bid requests, bid responses, and win notices. The aforementioned bidding data may likewise contain parameters pertaining to displaying an online ad such as a publisher ID, bid request ID, and impression ID. The ingestion mechanism may serve at least three purposes: (1) to alleviate congestion and latency within the blockchain network to prevent any data loss, (2) to combine or filter information received from one or more third parties to prepare the information for the blockchain network, and (3) to route the information to the nearest load balancer.

To accomplish the forgoing functions, the ingestion mechanism functions may be accomplished by one or more servers, or comparable computing devices, such as (a) a personal computer, (b) a remotely hosted computer, (c) a virtual server comprised of one or more virtual machines, (d) a bare metal machine, (d) a managed dedicated host, or (e) a containerized solution such as Docker or Kubernetes.

(B) Routing: In some embodiments, a single ledger set has a threshold of N requests, where N represents the maximum number of requests that a single ledger set is able to process per second. Transactions are sent to each ledger set based upon their maximum allowable throughput. The maximum allowable throughput may correspond to the volume of transactions that a single ledger set can process until it reaches its processing limit (i.e., the threshold number), which corresponds to the computational capacity of the server (or servers) functioning as the ledger set. Should the transaction rate exceed the maximum allowable throughput of a single ledger set, additional transactions will be routed to an alternative ledger set that shares the same smart contract application. For example, if the ledger set processing capacity is 1,000 transactions per second, and the blockchain network is receiving 10,000 transactions per second, the transactions would be routed to 10 ledger sets to process all transactions without increasing lag time. Thus, once a ledger set has reached its threshold, additional transactions beyond the threshold of the single ledger set are routed to a second ledger set until the second ledger set also reaches its threshold, whereupon additional transactions are routed to a third ledger set, and so on.

The number of ledger sets is therefore dependent upon the threshold of each individual single ledger set and the number of transactions per second received by the blockchain. As the number of transactions to the blockchain increase, so too may the number of ledger sets.

The process by which transactions are routed to a ledger set occurs via a load balancer. The load balancer is a device or application that distributes network or application traffic across multiple servers. In some embodiments, the load balancer is responsible for processing transaction metadata and assigning a distinct key to each transaction based on the transaction's unique metadata. The distinct key may come from a singular field contained within the transaction itself or be comprised of several fields of data, and may be referred to as a composite key. The distinct key is thereafter associated with a single ledger set from a list of available ledger sets. The load balancer utilizes the distinct key to always route traffic of said particular composite key to the same ledger set. The process whereby a distinct key's metadata fields is chosen is unique to the application and its underlying data.

In some embodiments, transactions may be distributed using a round robin or similar distribution method to evenly distribute transactions to the ledger sets. A hashing algorithm may also be employed on the distinct key outlined above to associate a hash with a transaction to ensure that related transactions, or sequential communications related to a common transaction, are distributed to the same ledger sets based on a common hash. This alternate mechanism of routing, known as “sticky sessions”, may be achieved by assigning a session-based tracking cookie containing the distinct hash value to the transaction request.

The routing and load balancing processes may be accomplished by one or more servers or comparable devices that act as a proxy between a transaction request and the associated ledger sets. The load balancing processes are dynamically updated with a pool of either the IP addresses or valid Domain Name System (DNS) hostnames of each participating ledger set. In the event a transaction hash is used, the load balancer uniquely assigns the transaction hash to one ledger set from the pool. The accompanying transaction is then proxied, or forwarded, from the server or comparable computing device to the associated ledger set. In this embodiment, the load balancer increases the system's throughput of transactions by means of routing them directly to ledger sets with available resources.

(C) Consent Nodes: Consent nodes within a blockchain are nodes that are permissioned or designated to validate and consent upon transaction data. Each set of consent nodes is only operable to consent on transactions that are designated for the consent node, however. As such, a first group of consent nodes may be associated with (and operable to consent upon) transactions allocated to the first ledger set, a second group of consent nodes may be associated with transactions allocated to the second ledger set, and so on. Accordingly, in the referenced configuration, consent nodes are given permission along with an ID (a unique identifying tag associated with each particular node) within the blockchain and associated to ledger sets. The node ID enables the blockchain to request specific validating nodes to consent on information based on their association with a ledger set. Thus, if a node is directly associated with transaction data that is in need of consensus, the node will be requested to consent based upon the node's ID. In such an instance, communication is made between the blockchain core framework and the node indicating a request to the node for consensus. Once consensus is reached by all validating nodes, each validating node stores the consented data within its own ledger inside of the ledger set to which the node is associated. It follows that in such an environment, all consenting nodes for a particular set of transaction data will be within the same ledger set.

Reading Ledgers: When a ledger set stores a consented upon transaction as a ledger entry, the ledger set is responsible for sending the transaction data to the reading ledger. The reading ledger function may also be executed by a server or comparable computing device. The reading ledger may be a distributed database that stores data related to the blockchain transactions.

The reading ledger may be used to handle subsequent lookup processes relating to transactions. To that end, additional metadata including the processing ledger set's name and location as well as a transaction hash associated with the ledger entry may be sent to the reading ledger. By receiving and storing this information, the reading ledger contains a full copy of all transactional data stored on all ledger sets in a data store. The purpose of the reading ledger is twofold: (1) the reading ledger enables a client facing application to directly access transaction data without impacting the read/write performance of the blockchain, and (2) the reading ledger provides verifiability that the transaction data has not been tampered with by means of referential integrity of the transaction hash. Using the transaction hash and ledger set hostname, the reading ledger is capable of requesting a transaction stored on the blockchain by way of an API call.

(E) Secondary Blockchain: Whereas an initial blockchain is considered as the system and protocol that receives data and routes to the ledger set(s), a secondary blockchain is considered to be the blockchain protocol used for the transfer or disbursement of a digital asset (e.g., a cryptocurrency). The secondary blockchain framework functions to establish consensus from one party to another based upon the data provided by the first blockchain (as described above with regard to the validating nodes). From the information within the ledger sets of the initial blockchain, any program on an internet connected device is able to request data through an application programming interface to connect with the initial blockchain for the purposes of either receiving data to place in the secondary blockchain or for the purposes of calculating other data which in turn is then placed in the secondary blockchain (e.g., reconciling financial transaction data to complete a payment or disbursement). In either scenario, two or more parties are involved and a blockchain transaction occurs. In one example, the first party would be accessing the initial blockchain ledger sets using the application programming interface, while the second party is a receiving party that receives a digital asset.

Referring now to the drawings, in the accompanying figures, reference numerals refer to identical or functionally similar elements throughout the separate views.

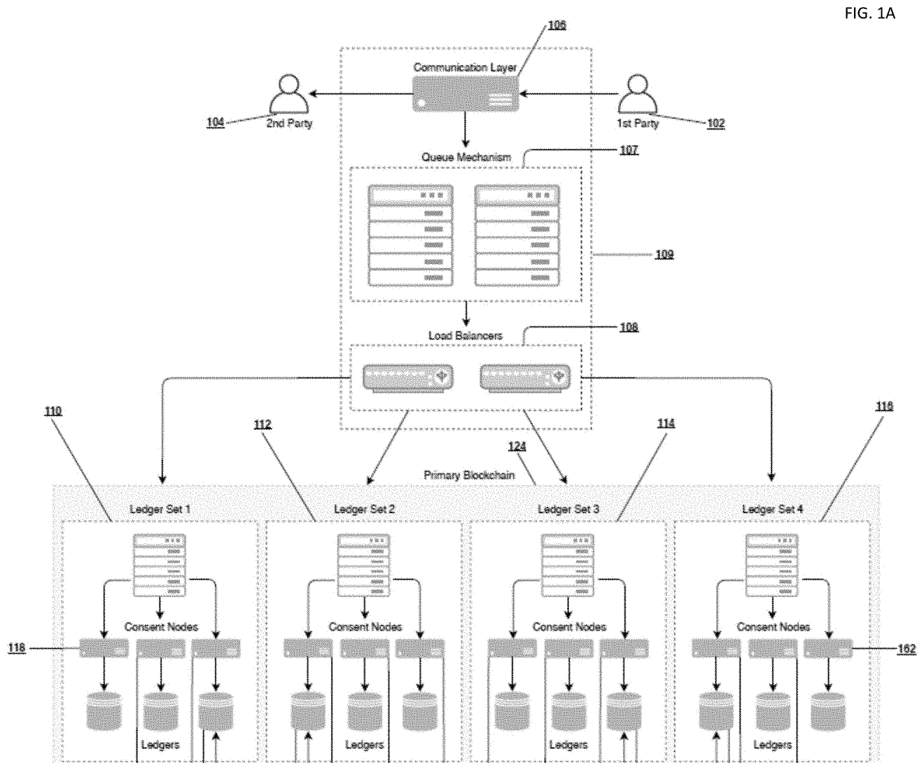

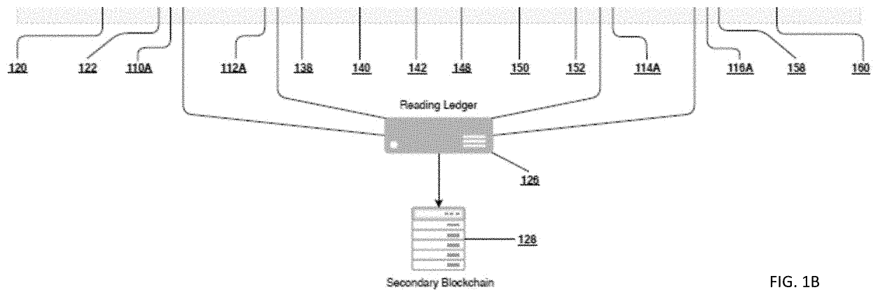

FIG. 1 shows a representative system 100, in which a first party 102 and a second party 104 are able to interface with the system 100 to complete a transaction. In a representative embodiment, the parties interface with the system 100 via a communication layer 106. The communication layer 106 consists of one or more servers, and may be accessed by the parties over a communication network, such as the internet.

The communication layer 106 is an intermediary between the parties and performs certain ingestion functions for the system 100. As such, the communication layer 106, which may be resident on a server, is communicatively coupled (via an API) to a queue 107 and load balancer 108 that cooperate to route data into the system 100. Each of the queue 107 and load balancer 108 may be resident on a common server, or on one or more servers that are separate from the communication layer 106. In some embodiments, the communication layer may be viewed as a first server, the queue may be viewed as a second server, and the load balancer may be viewed as a third server. The servers may be coupled to one another (as shown in FIG. 1) using any suitable communication network, including local area networks and wide area networks.

The load balancer 108 performs ingestion functions for the system 100. As such, the communications layer 106 and load balancer 108 may be viewed alternatively as components of an ingestion module 109. In the representative system, the load balancer 108 is communicatively coupled (over a network via an API) to a plurality of ledger sets (first ledger set 110, second ledger set 112, third ledger set 114, and fourth ledger set 116, up to n ledger sets). Each ledger set may in turn reside on a separate server and be communicatively coupled to one or more consent nodes (also referenced herein as validating nodes) via an API.

Each of the consent nodes may also be resident on a separate server or computing device. The first ledger set 110 may be communicatively coupled to a first consent node 118, second consent node 120, and third consent node 122, up to n consent nodes. Similarly, the second ledger set 112 may be communicatively coupled to a first consent node 138, second consent node 140, and third consent node 142, up to n consent nodes; the third ledger set 114 may be communicatively coupled to a first consent node 148, second consent node 150, and third consent node 152, up to n consent nodes; and the fourth first ledger set 116 may be communicatively coupled to a first consent node 158, second consent node 160, and third consent node 162, up to n consent nodes.

The ledger sets and consent nodes may be viewed as comprising an initial or primary blockchain 124. A secondary blockchain 128, is in turn coupled to a reading ledger 126. In some embodiments, the reading ledger 126 is a web-based application that is resident on a server and coupled to the ledger sets over a network. The reading ledger 126 is operable to look up data from any one of the ledger sets. The secondary blockchain 128 is operable to facilitate transactions by the blockchain to reconcile payments and conduct other blockchain transactions (e.g., cryptocurrency transactions, advertising transactions, auctions, and other smart contract-based transactions).

Referring again to FIG. 1, in operation, the system 100 may be used to complete a transaction (data, payment, etc . . . ) between the first party 102 and the second party 104. When the transaction is initiated, transaction data is split, with a portion going to the second party 104 and a portion going to the queue 107 and load balancer 108. The load balancer 108 may control timing of processing of the transaction to optimize latency (slowing the data down may be functionally necessary to allow processing of the blockchain) and may also reconcile transaction data to the extent necessary to facilitate downstream processing. The load balancer 108 also transmits the transaction data to one of the ledger sets. For example, by default, the load balancer 108 may transmit the transaction data to the first ledger set 110 unless the first ledger set is at capacity (or at its threshold volume of transactions), in which case the load balancer 108 instead transmits the transaction data to the second ledger set 112.

As an operative process of the system 100, a background application may be running at the load balancer 108 to activate the ledger sets. The background application may, for example, operate to create an additional ledger set when the ledger sets are concurrently in use at capacity, or beyond a selected capacity threshold (e.g., 70%, 80%, 90%, etc . . . ). When the data is transmitted to the ledger set (e.g., first ledger set 110), the consent nodes (e.g., consent nodes 118, 120, and 122) associated with the ledger set are notified to consider and consent to the subject transaction. The ledger lookup 126 is operable to conduct a database lookup function that can lookup data from the ledgers sets. Next, the transaction data (pulled by the ledger lookup 126) may be sent to a secondary blockchain 128 for further processing.

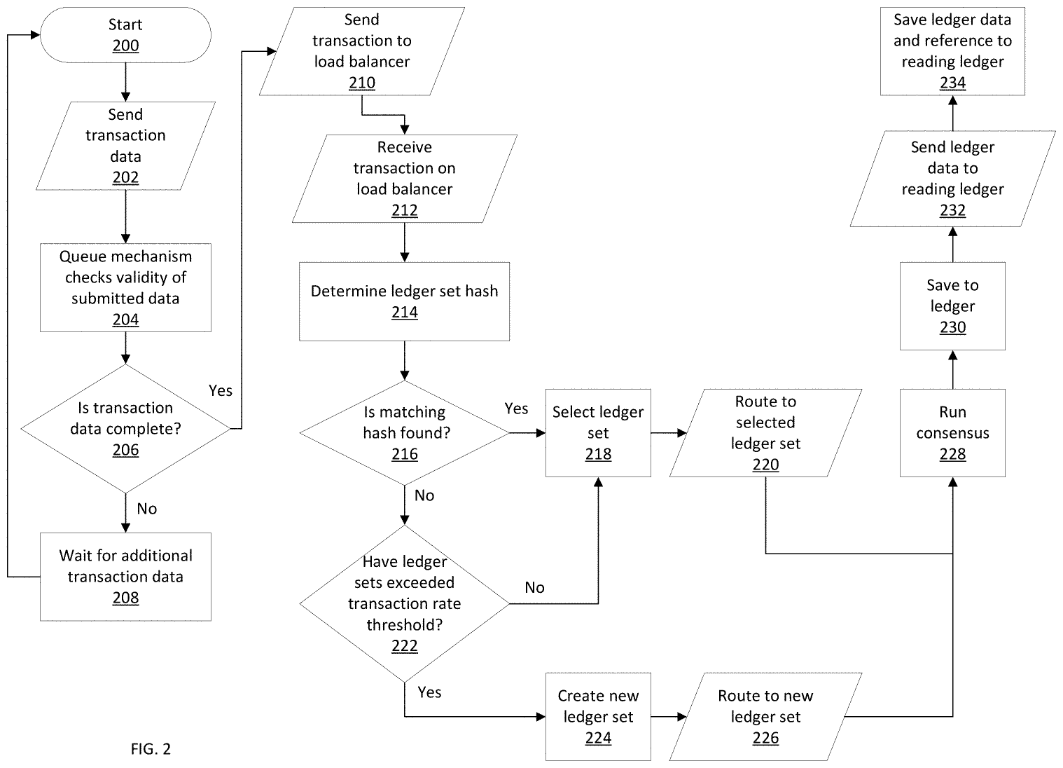

In view of the foregoing, a representative process is described with regard to FIG. 2. Here, the process starts (200) with, for example, a blockchain transaction. The process commences with the sending of transaction data 202 to, for example, an ingestion server. A queue mechanism of the ingestion server then checks the validity of the received transaction data 204 and determines whether the transaction data is complete 206. If the transaction data is not complete, the process waits for additional transaction data 208 and the process restarts. If the transaction data is complete, the transaction data is sent to the load balancer 210 and received at the load balancer 212, which determines a ledger set hash 214 associated with the transaction. The load balancer then determines whether a matching hash is found 216. If a matching hash is found, then the load balancer selects the ledger set to which the matching hash has been assigned 218 and routes the transaction data to the selected ledger set 220.

If a matching hash is not found, the load balancer determines whether the transaction rate of the existing ledger sets have exceeded a transaction rate threshold 222. If the transaction rate threshold has not been exceeded, then the load balancer selects an existing ledger set 218 and routes the transaction data to the selected ledger set 220. If the transaction rate threshold has been exceeded, then the load balancer creates a new ledger set 224 and routes the transaction data to the new ledger set 226 so that the ledger sets do not become overloaded and cause lag in transaction processing.

After routing to either an existing ledger set (220) or a newly created ledger set (226), a consensus is run 228, and the consented or validated transaction data is saved to the ledger 230. The transaction data is then sent to the reading ledger 232, and ledger data and reference data relating to the transaction is saved to the reading ledger 234, and the transaction is completed.

The illustrative system and methods may be further understood with regard to the following examples:

In a first exemplary process, a method of receiving transaction data from a first party 102 by a second party 104 includes providing data from the first party 102 to an ingestion mechanism 109, as described above with regard to FIG. 1. The transaction data is routed to a ledger set 110 and to a ledger 110A within the ledger set 110. Here, the first party 102 and second party 104 are sending communication data to the ingestion mechanism 109 for the purposes of communicating with one another and placing the communication data into the blockchain. The ingestion mechanism 109 may receive information (transaction data) from the first party 102 alone or from multiple parties. The transaction data intended for the blockchain may optionally be combined with other data to form more complete transaction data or held within a queue to be sent to the ledger set 110. The transaction is then transferred to the blockchain for consensus and entry into the reading ledger 126. In a representative system, time consensus of the nodes is performed at the ledger set 110, and consensus is reached between the nodes (e.g., first node 118, second node 120, and third node 122) within the blockchain framework and the consent data is sent to the reading ledger 126.

A second exemplary method includes receiving many transactions at once from one or more parties that may or may not be associated with one another. The method includes routing the transactions to one or multiple different ledger sets 110, 112, 114, and so on, depending on the number of transactions a single ledger set is able to process within a given time period. Here, the ingestion mechanism 109 holds the information received from one or more parties in a queue 107. The ingestion mechanism 109 also stores information for a period of time to allow for potential fluctuations in latency times of the ledger sets. The ingestion mechanism 109 may also combine data (where data combination is suitable for combining) prior to routing to a ledger set. Information is routed to different ledger sets from the ingestion mechanism 109 when the ledger sets are ready to receive the data. Distribution of the data to different ledger sets (e.g., second ledger set 112 and third ledger set 114) for consensus increases the number of transactions the associated blockchain framework is able to process within a given time period. In this example, transaction data is sent to and received into multiple ledger sets within the blockchain framework, and consents may be obtained by a single ledger set (e.g., first ledger set 110 or second ledger set 112) and saved or recorded to a reading ledger 126.

A third exemplary method includes operating a reading ledger 126 to read a first ledger 110 of an initial blockchain, wherein the data from the first ledger 110 of the initial blockchain is sent to the secondary blockchain. The reading ledger 126 is operable to read from an application programming interface to retrieve information stored in the first ledger 110 for one or more ledger set. As such, the reading ledger 126 is operable to transmit a request to the first ledger 110 for ledger information via a ledger application programming interface, and to receive a response and data from the first ledger 110. The reading ledger 126 is also operable to request and receive transactional data from a ledger relating to the secondary blockchain.

A fourth exemplary method includes using the ingestion mechanism 109 to route data to each of a plurality of ledger sets based upon the number of the consensus transactions a single blockchain framework can process within a given amount of time. The number of ledger sets increases depending on the number of transactions coming through the ingestion mechanism 109 within a given amount of time. When the threshold transaction limit is reached on a single ledger set (e.g., first ledger set 110), another ledger set (e.g., second ledger set 112) is created and transaction data for some new transactions is then sent to the newly created ledger set.

The ingestion mechanism 109 provides for transactions to be queued for entry into the primary blockchain 124 and routed based upon the number of transactions each individual ledger set 110, 112, 114, 116 (and so on) is able to process within a given time period. In this example, the ledger sets are operable to send transactional data to a corresponding ledger of a node after completion of consensus by the relevant validating nodes.

In a fifth example. an exemplary system for implementing the processes and functionality described above includes an application operating within a server (operating as a read ledger), which routes incoming requests received through a blockchain protocol to any number of server instances in which each server instance contains a blockchain framework. The system is operable to increase the number of transactions that are able to pass through a blockchain consensus algorithm by scaling the number of servers running validating nodes, in contrast to a single server instance running a single blockchain framework instance. The system may utilize a plurality of servers or server areas with the goal of increasing the number of transactions running through a blockchain that the system would otherwise be unable process using a single server (or server instance). Correspondingly, the amount of cryptocurrency that is able to be traded through an application or between multiple parties also increases by combining multiple instances blockchains together in accordance with the instant disclosure.

The first set of blockchain server instances (running a queue protocol and blockchain framework) is operable to execute the processes of a communication layer to receive transaction data. The second set of blockchain server instances (read protocol, blockchain framework) is complementary and operable to facilitate the transfer of (e.g.) cryptocurrency from one entity to another.

In the exemplary system, a first server or server area operates as a queue application to receive incoming data from two or more parties through a separate application or server and routes the incoming data to a given series of servers that are participating in the blockchain framework. The exemplary system may also include a second one or more servers, each running the same blockchain framework and operable to receive data transactions from the first server. The second server is operable to increase the number of servers participating in the blockchain framework based upon the number of incoming transactions into the second server area reaching a threshold number of transactions. As such, the second server area may include any suitable number of additional servers (e.g., one or one hundred), with the number of servers being dependent upon the number of transactions incoming from the first server. In the exemplary system, a third server operates to read the blockchain ledgers and to retrieve information from the ledgers through a hierarchical data tree structure.

The foregoing system may thereby be operable to execute the following exemplary method. In the exemplary method, a first step includes a receiving transaction data from two or more parties using a “queue” framework located on a first server. The purpose of the queue is to hold the transactions for a given period of time with the ability to control the flow of transactions entering the blockchain within the given period of time to decrease the latency and allow time for servers to be added to the blockchain. As transactions come into the queue, the transactions are held and then sent to the blockchain through a routing method.

In a second step, the blockchain scales (at the direction of the load balancer) based upon the number of servers running the blockchain framework. Here, it is noted that if a single ledger set (which may be a server instance) is able to perform 1,000 transactions per second, then by increasing the number of ledger sets, the number of transactions per second can similarly be increased. As transactions come in to the blockchain, the number of operating ledger sets thereby increases based upon the number of transactions that the then-currently running ledger sets are able to perform. As the currently running ledger sets reach their maximum number of transactions per second, an additional ledger set may be added to the blockchain processing network in order to receive and process the additional transactions.

In a third step, after consensus is performed within the blockchain framework (based on the second step), the data is placed within a ledger of the nodes that consented on the data within a particular ledger set. Not all nodes that are available to consent are able to consent on all data (because, as noted previously, only the nodes that are either associated directly with the data by their ID or that have otherwise been given access will have the ability to consent on specific data). Once the data is within ledgers, a separate application located on a single or multiple servers is able to search data within the ledgers through an API (application programming interface). The request through the API is done through the nodes/ledgers. It may be that one node or ledger functions as a leader and therefore has control over, and knowledge of location(s) of the servers (through IP or domain) and where to route lookup requests. For example, the data may be retrieved through a hierarchical data tree structure where values are stored and references (child identifiers) are located through levels of the lookup.

In a fourth step, once a lookup of data has been made in one or more ledgers, the application server that performed the lookup is able to send that data to a secondary blockchain for the purposes of either completing a cryptocurrency trade between two or more parties or for the purposes of placing data within a public-based blockchain.

As another example, two parties within an advertising supply chain may communicate advertising data between one another. In this supply chain, a supply-side platform (SSP) may send bid information to a demand-side Platform (DSP). In return, the DSP may send a bid response to the SSP. In this example, both the bid request and bid response data may be sent to the queue where both the bid request and bid response data could be combined or not depending on the need. The queue would then route the data to the blockchain framework to be consented upon and placed within (possibly newly operational) ledgers for the purposes of verifying that the data is correct and uncorrupted between the two parties. Once the data is written to the ledgers, a separate application is able to read this data and send this on to a secondary blockchain for contract creation and consensus.

In the systems and methods described herein, the purpose of the first blockchain is to (i) increase the number of transactions a blockchain framework is able to receive per second in which it would otherwise be unable to do so by itself without the help of a queue application and multiple server instances of a blockchain framework, (ii) allow for private information to be consented upon by parties that have been given permission to do so, and (iii) increase security of blockchain consensus and data transfer. The purpose of the secondary blockchain is to (I) place data between two parties on a public blockchain framework, (II) associate transactions of the first blockchain to the sending and receiving payments on a cryptocurrency blockchain, and (III) allow for the transfer and exchange from data to cryptocurrency in which the data itself has a purpose (distributed and reconciled data between parties) and payment based upon the data consented upon.

In the example provided, the bid request/response not only has data located within it, but also includes payment information. The data is thereby placed within the first blockchain, while the secondary blockchain functions as a mechanism of payment.

In the current state of the art, single blockchain frameworks limit the amount of data that can be transferred, leading to processing bottlenecks. As described above, this problem may be solved by sharing the processing load between different instances of the blockchain framework. In the disclosed embodiments, transactions may be mapped and routed to an appropriate node. Thus, if two parties, A and B, do a transaction, the “AB” transaction may be mapped and routed to a first ledger set. If the same two parties (A and B) do a second transaction and it goes to another ledger set, an ingestion mechanism may recognize the parties (A and B) and route the second transaction away from the other ledger set and back to the first ledger set.

In view of the above disclosure, it is noted that the systems and methods described herein provide for (i) taking a single blockchain and increasing the number of consensus at a time by distributing the transactions among multiple different instances of the same blockchain; (ii) distributing requests to multiple blockchains in a manner where the outcome is that the information contained in the transactions results in an entry into a decentralized ledger on one or more of the distributed instances of the blockchain; (iii) distributing transactions among multiple blockchains, to enable the nodes to consent (or not) to more transactions at a faster rate per time (sec, min, hour . . . etc.); (iv) instances of the blockchain being maintained by a single party; of multiple; (v) consensus from each instance being made from a multitude of machines managed by separate parties (nodes); and (vi) all transactions being done within a decentralized and distributed manner in which a consensus among nodes are made and placed into a private or public ledger.

While detailed illustrative embodiments are disclosed herein, the disclosed embodiments are merely examples and the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The present disclosure is being presented for purposes of illustration and description but is not intended to be exhaustive or limited to the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of enhancing the performance of a blockchain network, the method comprising:
receiving blockchain transaction data at an ingestion server;
determining whether the transaction rate of ledger set servers participating in the blockchain network exceeds a threshold transaction rate;
causing an additional ledger set server to participate in the blockchain network if the transaction rate exceeds the threshold transaction rate; and
transmitting the transaction data to the additional ledger set server for processing.

2. The method of claim 1, further comprising obtaining a consensus to validate a blockchain transaction corresponding to the blockchain transaction data.

3. The method of claim 2, further comprising saving the blockchain transaction to a ledger of the additional ledger set.

4. The method of claim 3, further comprising sending ledger data to a reading ledger.

5. The method of claim 1, wherein the ingestion server comprises a queue server and a load balancer server.

6. The method of claim 5, further comprising determining a hash value at the load balancer server and associating the hash value with the blockchain transaction data.

7. The method of claim 6, further comprising receiving second blockchain transaction data at the load balancer server and determining a second hash value corresponding to the second blockchain transaction data.

8. The method of claim 7, further comprising:
determining whether the second hash value is equivalent to a previously determined hash value corresponding to previously received blockchain transaction data;
routing the second blockchain transaction data to an existing ledger set server of the blockchain network if the second hash value is determined to be equivalent to the previously determined hash value, the existing ledger set corresponding to the previously received blockchain transaction data.

9. A system for processing a blockchain transaction comprising:
a first server operating a communications layer, the first server comprising an ingestion server and a queue;
a second server operating a load balancer;
a third plurality of servers, each of the third plurality of servers comprising a ledger set; and
a plurality of groups of consent nodes, with each group of consent nodes being associated with a ledger set,
wherein the second server comprises instructions for routing transactions including:
receiving blockchain transaction data at the first server;
determining whether the transaction rate of the third plurality of servers exceeds a threshold transaction rate;
adding an additional ledger set server to the third plurality of servers if the transaction rate exceeds the threshold transaction rate; and
transmitting the blockchain transaction data to the additional ledger set server for processing.

10. The system of claim 9, further comprising a plurality of consent nodes operable to obtain a consensus to validate a blockchain transaction corresponding to the blockchain transaction data.

11. The system of claim 9, further comprising a reading ledger server.

12. The system of claim 9, wherein the load balancer is operable to determine a hash value at the load balancer server and associating the hash value with the blockchain transaction data.

13. The system of claim 12, wherein the load balancer is operable to receive second blockchain transaction data and to determine a second hash value corresponding to the second blockchain transaction data.

14. The system of claim 13, wherein the load balancer is further operable to determine whether the second hash value is equivalent to a previously determined hash value corresponding to previously received blockchain transaction data, and to route the second blockchain transaction data to an existing ledger set server of the blockchain network if the second hash value is determined to be equivalent to the previously determined hash value, the existing ledger set corresponding to the previously received blockchain transaction data.
